(19) United States
(12) Patent Application Publication
(10) Pub. No.: US 2026/0032558 A1
(43) Pub. Date: Jan. 29, 2026

(54) COEXISTENCE OF U2U DISCOVERY AND U2N DISCOVERY

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/995,005

(22) PCT Filed: Aug. 8, 2023
(86) PCT No.: PCT/US2023/029707

§ 371 Date: Jan. 15, 2025

Related U.S. Application Data
(60) Provisional application No. 63/396,334, filed on Aug. 9, 2022.

(51) Int. Cl. H04W 40/24; H04B 17/318; H04W 76/27

(52) U.S. Cl. CPC H04W 40/24; H04B 17/328; H04W 76/27

(57) ABSTRACT

The examples set forth herein are directed towards scenarios in which UE devices have the option to use either U2U discovery or U2N discovery. In these scenarios, the UE devices can be configured to facilitate selection of a discovery procedure (e.g., U2U discovery or U2N discovery) that corresponds with a preferred type of relaying (e.g., U2U relaying or U2N relaying). More specifically, the UE devices can transmit various messages to each other in order to exchange information that facilitates selection of CN the type of relaying to be used.

### CLAIM OF PRIORITY

The present application claims priority to Provisional Application No. 63/396,334, entitled “U2U RELAYING—DISCOVERY AND RELAY RESELECTION,” docket number TPRO 00377 US, filed Aug. 9, 2022, which is assigned to the assignee hereof and hereby expressly incorporated by reference in its entirety.

### FIELD

This invention generally relates to wireless communications and more particularly to discovery and relay reselection.

### BACKGROUND

Sidelink relaying functionality allows a remote user equipment (UE) device that is out-of-coverage (OoC) to connect with the gNB or base station via a relay UE device.

### SUMMARY

The examples set forth herein are directed towards scenarios in which UE devices have the option to use either U2U discovery or U2N discovery. In these scenarios, the UE devices can be configured to facilitate selection of a discovery procedure (e.g., U2U discovery or U2N discovery) that corresponds with a preferred type of relaying (e.g., U2U relaying or U2N relaying). More specifically, the UE devices can transmit various messages to each other in order to exchange information that facilitates selection of the type of relaying to be used.

### BRIEF DESCRIPTION OF THE DRAWINGS

FIG. 1A is a block diagram of an example of a system in which a remote user equipment (UE) device and a destination UE device are both out-of-coverage (OoC), but a relay UE device is in-coverage (inC).

FIG. 1B is a block diagram of an example of the system of FIG. 1A in which the remote UE device, the relay UE device, and the destination UE device are all OoC.

FIG. 1C is a block diagram of an example of the system of FIG. 1A in which the remote UE device and the relay UE device are both OoC, but the destination UE device is inC.

FIG. 2A is a block diagram of an example of the base station shown in FIGS. 1A, 1B, and 1C.

FIG. 2B is a block diagram of an example of the user equipment devices shown in FIGS. 1A, 1B, and 1C.

FIG. 3 is a flow chart of an example of a method performed at a relay UE device of handling the coexistence of UE-to-UE (U2U) discovery and UE-to-Network (U2N) discovery.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE device and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (destination UE device), the relaying functionality is typically referred to as UE-to-UE (U2U) relaying.

Thus, sidelink relaying functionality allows a remote UE device that is out-of-coverage (OoC) to connect with the gNB or base station via a relay UE device. With UE-to-Network (U2N) relaying, the relay UE device needs to be in coverage of a cell and connected to the gNB. The relayed connection from the remote UE device to the base station (gNB) includes (1) a PC5 link (sidelink) between the remote UE device and the relay UE device, and (2) a direct communication link (e.g., Uu link) between the relay UE device and the gNB.

With U2U relaying, the relay UE device is not required to be in coverage of a cell and connected to the gNB. Rather, the relay UE device may be in coverage or OoC of the cell.

In addition to selecting between U2N relaying and U2U relaying, the remote UE device and the relay UE device may utilize Model A or Model B discovery procedures to discover each other as part of the relay selection and reselection procedure. With Model A discovery, either the remote UE device or the relay UE device may announce their presence by transmitting a discovery message indicating “I am here,” and the transmitting UE device does not expect a response to the message. With Model B discovery, either the remote UE device or the relay UE device transmits a discovery message requesting “Are you there?,” and the UE device that receives the discovery message containing the request may respond by transmitting a message indicating the presence of the UE device that received the discovery message.

Regardless of which discovery procedure is ultimately selected, one of the important factors in the discovery procedure is determining which resource will be used to transmit the discovery announcements. In general, if the UE device is in coverage of a cell, the discovery resource should be controlled by the gNB, and if the UE device is OoC, the UE device may use a pre-configured discovery resource. The following description addresses some of the use cases in which it may be advantageous to facilitate selection of a discovery procedure when both U2N and U2U discovery are available, which can affect which resource will be used for discovery and relaying.

Although the techniques discussed herein may be applied to various types of systems and communication specifications, the devices described herein operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D is employed. More specifically, the techniques may be applied to current and future releases of 3GPP NR specifications. For example, the techniques may also be applied to 3GPP NR (3GPP Rel-17) and 3GPP Rel-18.

The examples set forth herein are directed towards scenarios in which UE devices have the option to use either U2U discovery or U2N discovery. In these scenarios, the UE devices can be configured to facilitate selection of a discovery procedure (e.g., U2U discovery or U2N discovery) that corresponds with a preferred type of relaying. More specifically, the UE devices can transmit various messages to each other in order to exchange information that facilitates selection of the type of relaying to be used.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

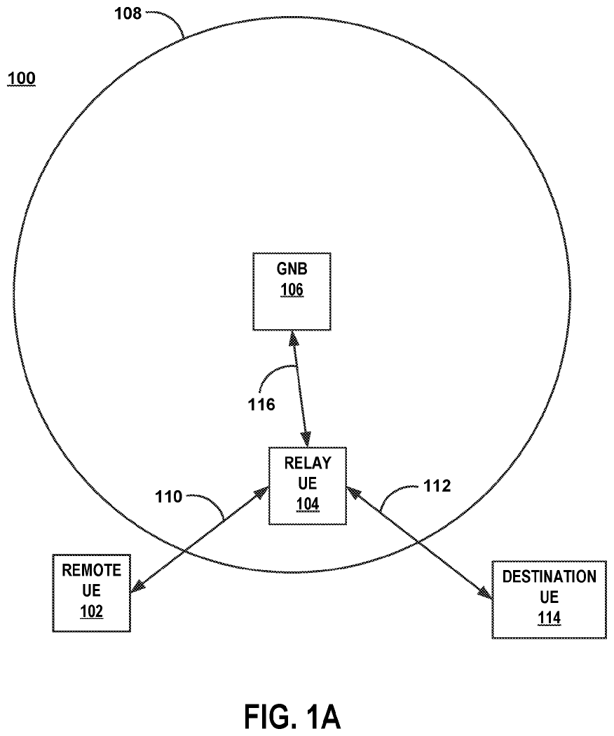

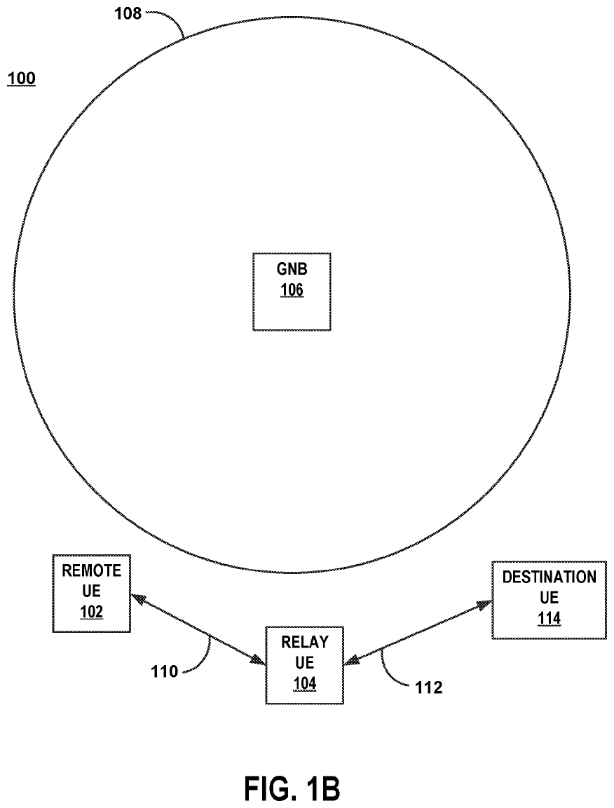

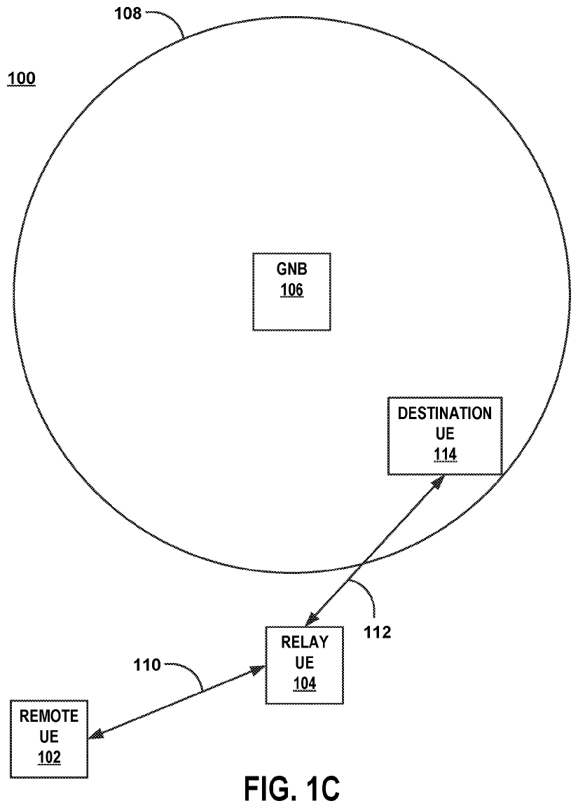

FIG. 1A is a block diagram of an example of a system in which a remote user equipment (UE) device and a destination UE device are both out-of-coverage (OoC), but a relay UE device is in-coverage (inC). In the interest of brevity, FIG. 1A only depicts one remote UE device 102, one relay UE device 104, and one destination UE device 114. However, any number of remote UE devices, relay UE devices, and destination UE devices may be utilized, in other examples.

Remote UE device 102 may also be referred to herein as a remote UE, a remote wireless communication device (WCD), or a source UE device. Relay UE device 104 may also be referred to herein as a relay UE or a relay WCD. Destination UE device 114 may also be referred to herein as a destination UE or a destination WCD. Moreover, any of the UE devices herein may be described as D2D devices when they are transmitting data signals to each other over a communication link using cellular resources instead of communicating through a base station.

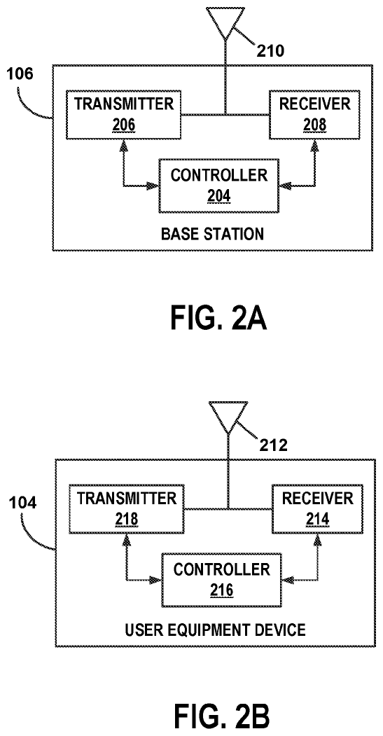

As shown in FIG. 2B, user equipment (UE) device 104 comprises controller 216, transmitter 218, receiver 214, and antenna 212, as well as other electronics, hardware, and software code. UE 104 is wirelessly connected to a radio access network (not shown) via base station 106, which provides various wireless services to UE 104. For the example shown in FIG. 1A, UE 104 operates in accordance with at least one revision of the 3rd Generation Partnership Project 5G New Radio (3GPP 5G NR) communication specification. In other examples, UE 104 may operate in accordance with other communication specifications. For the example shown in FIG. 1A, all of the UE devices have the same components, circuitry, and configuration as UE 104 from FIG. 2B. However, any of the UE devices in FIG. 1A may have components, circuitry, and configuration that differ from UE 104, in other examples.

UE 104 is any fixed, mobile, or portable equipment that performs the functions described herein. The various functions and operations of the blocks described with reference to UE 104 may be implemented in any number of devices, circuits, or elements. Two or more of the functional blocks may be integrated in a single device, and the functions described as performed in any single device may be implemented over several devices.

Controller 216 includes any combination of hardware, software, and/or firmware for executing the functions described herein as well as facilitating the overall functionality of a user equipment device. An example of a suitable controller 216 includes software code running on a microprocessor or processor arrangement connected to memory. Transmitter 218 includes electronics configured to transmit wireless signals. In some situations, transmitter 218 may include multiple transmitters. Receiver 214 includes electronics configured to receive wireless signals. In some situations, receiver 214 may include multiple receivers. Receiver 214 and transmitter 218 receive and transmit signals, respectively, through antenna 212. Antenna 212 may include separate transmit and receive antennas. In some circumstances, antenna 212 may include multiple transmit and receive antennas.

Transmitter 218 and receiver 214 in the example of FIG. 2B perform radio frequency (RF) processing including modulation and demodulation. Receiver 214, therefore, may include components such as low noise amplifiers (LNAs) and filters. Transmitter 218 may include filters and amplifiers. Other components may include isolators, matching circuits, and other RF components. These components in combination or cooperation with other components perform the user equipment device functions. The required components may depend on the particular functionality required by the user equipment device.

Transmitter 218 includes a modulator (not shown), and receiver 214 includes a demodulator (not shown). The modulator can apply any one of a plurality of modulation orders to modulate the signals to be transmitted by transmitter 218. The demodulator demodulates received signals, in accordance with one of a plurality of modulation orders.

In the interest of clarity and brevity, only one base station is shown in FIG. 1A. However, in other examples, any suitable number of base stations may be utilized. In the example of FIG. 1A, base station 106 provides wireless services to UEs within coverage area 108. Although not explicitly shown, coverage area 108 may be comprised of multiple cells. For the example shown in FIG. 1A, base station 106, sometimes referred to as a gNodeB or gNB, can receive uplink messages from UE devices and can transmit downlink messages to the UE devices.

Base station 106 is connected to the network through a backhaul (not shown) in accordance with known techniques. As shown in FIG. 2A, base station 106 comprises controller 204, transmitter 206, receiver 208, and antenna 210 as well as other electronics, hardware, and code. Base station 106 is any fixed, mobile, or portable equipment that performs the functions described herein. The various functions and operations of the blocks described with reference to base station 106 may be implemented in any number of devices, circuits, or elements. Two or more of the functional blocks may be integrated in a single device, and the functions described as performed in any single device may be implemented over several devices.

For the example shown in FIG. 2A, base station 106 may be a fixed device or apparatus that is installed at a particular location at the time of system deployment. Examples of such equipment include fixed base stations or fixed transceiver stations. In some situations, base station 106 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, base station 106 may be a portable device that is not fixed to any particular location. Accordingly, base station 106 may be a portable user device such as a UE device in some circumstances.

Controller 204 includes any combination of hardware, software, and/or firmware for executing the functions described herein as well as facilitating the overall functionality of base station 106. An example of a suitable controller 204 includes code running on a microprocessor or processor arrangement connected to memory. Transmitter 206 includes electronics configured to transmit wireless signals. In some situations, transmitter 206 may include multiple transmitters. Receiver 208 includes electronics configured to receive wireless signals. In some situations, receiver 208 may include multiple receivers. Receiver 208 and transmitter 206 receive and transmit signals, respectively, through antenna 210. Antenna 210 may include separate transmit and receive antennas. In some circumstances, antenna 210 may include multiple transmit and receive antennas.

Transmitter 206 and receiver 208 in the example of FIG. 2A perform radio frequency (RF) processing including modulation and demodulation. Receiver 208, therefore, may include components such as low noise amplifiers (LNAs) and filters. Transmitter 206 may include filters and amplifiers. Other components may include isolators, matching circuits, and other RF components. These components in combination or cooperation with other components perform the base station functions. The required components may depend on the particular functionality required by the base station.

Transmitter 206 includes a modulator (not shown), and receiver 208 includes a demodulator (not shown). The modulator modulates the signals that will be transmitted and can apply any one of a plurality of modulation orders. The demodulator demodulates any uplink signals received at base station 106 in accordance with one of a plurality of modulation orders.

There are several scenarios when UE devices have the option to use either U2U discovery or U2N discovery. In these scenarios, the devices and systems can be configured to facilitate selection of a discovery procedure (e.g., U2U discovery or U2N discovery) that corresponds with a preferred type of relaying. Thus, a U2U discovery procedure is used to implement U2U relaying, and a U2N discovery procedure is used to implement U2N relaying.

FIGS. 1A-1C illustrate scenarios in which either relay UE device 104 and/or destination UE device 114 are OoC. For the example shown in FIG. 1A, relay UE device 104 is in-coverage (inC) of base station 106, and remote UE device 102 and destination UE device 114 are both out-of-coverage (OoC). Base station 106 and relay UE device 104 are connected by Uu link 116, which is the radio interface between a base station and a UE device. In the example shown in FIG. 1A, remote UE device 102 and relay UE device 104 are connected by communication link 110, which is a PC5 communication link (sidelink), and relay UE device 104 and destination UE device 114 are connected by communication link 112, which is another PC5 communication link.

FIG. 1B is a block diagram of an example of the system of FIG. 1A in which remote UE device 102, relay UE device 104, and destination UE device 114 are all OoC. FIG. 1C is a block diagram of an example of the system of FIG. 1A in which remote UE device 102 and relay UE device 104 are both OoC, but destination UE device 114 is inC of base station 106.

In other scenarios (not explicitly shown), relay UE device 104 and destination UE device 114 may both be in-coverage of the same base station 106, or relay UE device 104 may be in-coverage of a first base station and destination UE device 114 may be in-coverage of a second base station. Of course, any of the devices, systems, and methods described herein may be applicable to any other suitable scenarios in which the UE devices have the option to use either U2U discovery or U2N discovery.

Selection between U2U discovery or U2N discovery may depend on whether the destination UE device is in-coverage and/or whether the destination UE device is reachable directly by the relay UE device. If the destination UE device is OoC, then it may not be helpful for the remote UE device (e.g., source UE device) to select a candidate relay UE device based on U2N discovery. Alternatively, if the destination UE device is in-coverage and is also reachable by the candidate relay UE device, both U2N relaying and U2U relaying may be supported.

The choice between U2N relaying and U2U relaying may depend on several factors. For example, U2N relaying may be more reliable, in some cases, since service continuity and multipaths can be supported. In other cases, U2U relaying may be more reliable when the destination UE device is near a cell edge.

As discussed more fully below, the UE devices can transmit various messages to each other in order to exchange information that facilitates selection of the type of relaying to be used. In this regard, it is assumed that relay UE device 104, which is capable of both U2U relaying and U2N relaying, sends U2U discovery messages and U2N discovery messages independently. Thus, in these examples, relay UE device 104 would transmit two separate discovery messages (e.g., a U2U discovery message and a U2N discovery message), each having their own respective Layer 2 Identifier (L2ID).

In operation, relay UE device 104 transmits, via its transmitter 218 and antenna 212, to remote UE device 102, a first discovery message containing information pertaining to destination UE device 114. In some examples, the information pertaining to destination UE device 114 comprises a coverage status of destination UE device 114. In other examples, the information pertaining to destination UE device 114 comprises a Radio Resource Control (RRC) state of destination UE device 114. In further examples, the information pertaining to destination UE device 114 comprises a Reference Signal Received Power (RSRP) measurement of a Uu communication link between destination UE device 114 and a base station.

In still further examples, the information pertaining to destination UE device 114 may include an indication of a preferred discovery procedure of destination UE device 114. For example, prior to sending the first discovery message, relay UE device 104 may receive, from destination UE device 114, a discovery message indicating a preferred discovery procedure (e.g., U2U or U2N) of destination UE device 114. More specifically, destination UE device 114 may determine whether U2N relaying or U2U relaying is preferred, based on the coverage status and/or RRC state of destination UE device 114, in some examples. In these examples, destination UE device 114 may include an indication of its preferred discovery procedure in a discovery message transmission (e.g., Model B response) to relay UE device 104, and relay UE device 104 may include the preferred discovery procedure of destination UE device 114 in the first discovery message.

In some examples, relay UE device 104 obtains the information pertaining to destination UE device 114 (e.g., the coverage status of destination UE device 114, the RSRP measurement of the Uu link between destination UE device 114 and a base station, and/or RRC state of destination UE device 114) in a transmission received from destination UE device 114, preferably in a Model B response message sent in response to a Model B request message transmitted by relay UE device 104. In other examples in which relay UE device 104 is already PC5 connected to destination UE device 114, relay UE device 104 may already be aware of the information pertaining to destination UE device 114 (e.g., the coverage status of destination UE device 114, the RSRP measurement of the Uu link between destination UE device 114 and a base station, and/or RRC state of destination UE device 114). Alternatively, relay UE device 104 may request the information pertaining to destination UE device 114. For example, relay UE device 104 may request the RRC state from destination UE device 114 using a PC5-RRC message such as RRCReconfigurationSidelink, and in response, destination UE device 114 would transmit a corresponding response message RRCReconfigurationCompleteSidelink indicating the RRC state of destination UE device 114.

In the foregoing examples in which the first discovery message contains information pertaining to destination UE device 114, the first discovery message is a U2U discovery message. In other examples, the first discovery message is a U2N discovery message, in which case the U2N discovery message would not include information pertaining to a destination UE device. However, as mentioned above, relay UE device 104 is not limited to transmitting a single type of discovery message and may transmit both U2U discovery messages and U2N discovery messages, in some examples.

Remote UE device 102 receives, via its antenna 212 and receiver 214, the first discovery message. Remote UE device 102 utilizes its controller 216 to determine, based upon the first discovery message, whether to perform a UE-to-Network (U2N) discovery procedure or a UE-to-UE (U2U) discovery procedure. In the examples in which remote UE device 102 receives both a U2U discovery message and a U2N discovery message, remote UE device 102 can select whether to perform U2U discovery or U2N discovery.

In the examples in which the first discovery message contains information pertaining to destination UE device 114, remote UE device 102 determines whether to perform a U2N discovery procedure or a U2U discovery procedure, based upon the information pertaining to destination UE device 114. In other examples in which a destination UE device of interest is not identified in the first discovery message, remote UE device 102 may select to perform a U2N discovery procedure in order to implement U2N relaying.

Upon determining which discovery procedure to perform, remote UE device 102 transmits, to relay UE device 104, a message indicating a preferred discovery procedure. In some examples, the message indicating the preferred discovery procedure of remote UE device 102 is a Direct Communication Request message. In other examples, the message indicating the preferred discovery procedure of remote UE device 102 is a PC5-S message such as a Model A discovery message or a Discovery preference message received via an established PC5 unicast connection between remote UE device 102 and relay UE device 104.

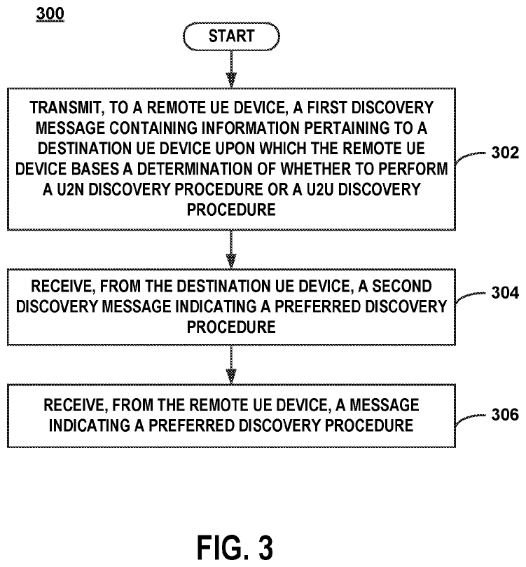

FIG. 3 is a flow chart of an example of a method performed at a relay UE device of handling the coexistence of UE-to-UE (U2U) discovery and UE-to-Network (U2N) discovery. For the example, therefore, the method may be performed by relay UE device 104.

At step 302, the relay UE device transmits, to a remote UE device, a first discovery message containing information pertaining to a destination UE device upon which the remote UE device bases a determination of whether to perform a U2N discovery procedure or a U2U discovery procedure.

At step 304, the relay UE device receives, from the destination UE device, a second discovery message indicating a preferred discovery procedure of the destination UE device. At step 306, the relay UE device receives, from the remote UE device, a message indicating a preferred discovery procedure of the remote UE device.

In other examples, one or more of the steps of method 300 may be omitted, combined, performed in parallel, or performed in a different order than that described herein or shown in FIG. 3. In still further examples, additional steps may be added to method 300 that are not explicitly described in connection with the example shown in FIG. 3.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a transmitter configured to transmit, to a remote UE device, a first discovery message containing information pertaining to a destination UE device upon which the remote UE device bases a determination of whether to perform a UE-to-Network (U2N) discovery procedure or a UE-to-UE (U2U) discovery procedure.

2. The relay UE device of claim 1, wherein the first discovery message is a U2U discovery message.

3. The relay UE device of claim 1, wherein the information pertaining to the destination UE device comprises a coverage status of the destination UE device.

4. The relay UE device of claim 1, wherein the information pertaining to the destination UE device comprises a Radio Resource Control (RRC) state of the destination UE device.

5. The relay UE device of claim 1, wherein the information pertaining to the destination UE device comprises a Reference Signal Received Power (RSRP) measurement of a Uu communication link between the destination UE device and a base station.

6. The relay UE device of claim 1, further comprising:
a receiver configured to receive, from the destination UE device, a second discovery message indicating a preferred discovery procedure.

7. The relay UE device of claim 1, further comprising:
a receiver configured to receive, from the remote UE device, a message indicating a preferred discovery procedure.

8. The relay UE device of claim 7, wherein the message indicating the preferred discovery procedure is a Direct Communication Request message.

9. The relay UE device of claim 7, wherein the message indicating the preferred discovery procedure is a PC5-S message received via an established PC5 unicast connection between the remote UE device and the relay UE device.

10. A remote user equipment (UE) device comprising:
a receiver configured to receive, from a relay UE device, a first discovery message containing information pertaining to a destination UE device; and
a controller configured to determine, based upon the information pertaining to the destination UE device, whether to perform a UE-to-Network (U2N) discovery procedure or a UE-to-UE (U2U) discovery procedure.

11. The remote UE device of claim 10, wherein the first discovery message is a U2U discovery message.

12. The remote UE device of claim 10, wherein the information pertaining to the destination UE device comprises a coverage status of the destination UE device.

13. The remote UE device of claim 10, wherein the information pertaining to the destination UE device comprises a Radio Resource Control (RRC) state of the destination UE device.

14. The remote UE device of claim 10, wherein the information pertaining to the destination UE device comprises a Reference Signal Received Power (RSRP) measurement of a Uu communication link between the destination UE device and a base station.

15. The remote UE device of claim 10, further comprising:
a transmitter configured to transmit, to the relay UE device, a message indicating a preferred discovery procedure.

16. The remote UE device of claim 15, wherein the message indicating the preferred discovery procedure is a Direct Communication Request message.

17. The remote UE device of claim 15, wherein the message indicating the preferred discovery procedure is a PC5-S message transmitted via an established PC5 unicast connection between the remote UE device and the relay UE device.
